(19) United States
(12) Patent Application Publication
(10) Pub. No.: US 2004/0003007 A1
(43) Pub. Date: Jan. 1, 2004

(54) Windows management instrument synchronized repository provider

(76) Inventors: John M. Prall, Cave Creek, AZ (US); Jason T. Urso, Cave Creek, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/346,276

(22) Filed: Jan. 16, 2003

Related U.S. Application Data
(60) Provisional application No. 60/392,724, filed on Jun. 28, 2002.

(51) Int. Cl. G06F 12/00

(52) U.S. Cl. 707/200

(57) ABSTRACT

A method and synchronized data repository provider that synchronize data of repositories among a plurality of computing nodes is disclosed. Each node includes a synchronized provider, which communicates with the synchronized providers in the other nodes to synchronize the data of the repositories. The communication is with data synchronization messages, which are multicast by a sending node via a multicast communication link to all of the other nodes. A synchronization scope as well as a class limits the data of a repository. A repository is initialized via a point-to-point communication link with another node. The method and synchronized provider include the capability to handle response storms, lost messages and duplicate messages.

This Application claims the benefit of U.S. Provisional Application No. 60/392,724 filed Jun. 28, 2002.

### FIELD OF THE INVENTION

This invention generally relates to synchronization of data repositories among a plurality of computing nodes connected in a network and, more particularly, to methods and devices for accomplishing the synchronization in a Windows Management Instrumentation (WMI) environment.

### BACKGROUND OF THE INVENTION

Web-Based Enterprise Management (WBEM) is an initiative undertaken by the Distributed Management Task Force (DMTF) to provide enterprise system managers with a standard, low-cost solution for their management needs. The WBEM initiative encompasses a multitude of tasks, ranging from simple workstation configuration to full-scale enterprise management across multiple platforms. Central to the initiative is a Common Information Model (CIM), which is an extensible data model for representing objects that exist in typical management environments.

WMI is an implementation of the WBEM initiative for Microsoft® Windows® platforms. By extending the CIM to represent objects that exist in WMI environments and by implementing a management infrastructure to support both the Managed Object Format (MOF) language and a common programming interface, WMI enables diverse applications to transparently manage a variety of enterprise components.

The WMI infrastructure includes the following components:

The actual WMI software (Winmgmt.exe), a component that provides applications with uniform access to management data.

The Common Information Model (CIM) repository, a central storage area for management data.

The CIM Repository is extended through definition of new object classes and may be populated with statically defined class instances or through a dynamic instance provider.

The WMI infrastructure does not support guaranteed delivery of events, or provide a mechanism for obtaining a synchronized view of distributed data. Clients must explicitly connect to each data source for instance enumeration and registration for event notification. Connection problems, such as termination of data servers or network problems result in long delays in client notification and reconnection to a disconnected data source. These problems may yield a broken callback connection with no indication of the problem to the client. The solution to these problems must avoid the overhead of multiple connections by each client as well as avoid loss of event data when connections cannot be established. The delivery of data cannot be interrupted when a single connection fails, and timeouts associated with method calls to disconnected servers must be minimized. Delivery of change notifications must be guaranteed without requiring periodic polling of data sources.

One approach to providing a composite view of management data is to develop a common collector server. However, implementation of a common server yields a solution with a single point of failure and still relies on all clients connecting to a remote source. High availability server implementation and redundant server synchronization can be complicated and client/server connection management is still a major problem.

The present invention also provides many additional advantages, which shall become apparent as described below.

### SUMMARY OF THE INVENTION

The Synchronized Repository Provider (SRP) of the present invention is a dynamic WMI extrinsic event provider that implements a reliable IP Multicast based technique for maintaining synchronized WBEM repositories of distributed management data. The SRP is a common component for implementation of a Synchronized Provider. The SRP eliminates the need for a dynamic instance provider or instance client to make multiple remote connections to gather a composite view of distributed data. The SRP maintains state of the synchronized view of registered Synchronized Provider repository data. The SRP initially synchronizes the distributed view of repository contents and then guarantees delivery of data change events. A connectionless communication protocol minimizes the affect of network/computer outages on the connected clients and servers. Use of IP Multicast reduces the impact on network bandwidth and simplifies configuration. The SRP implements standard WMI extrinsic event and method provider interfaces providing a published, open interface for Synchronized Provider development. No custom libraries or proxy files are required to implement or install the SRP, a Synchronized Provider, or a client.

The method of the present invention provides communication between a local node and a plurality of remote nodes in a computing system for the synchronization of data. The method communicates data synchronization messages concerning the data of a repository in a multicast mode via a multicast communication link that interconnects all of the nodes.

According to one embodiment of the method of the present invention, at least one of the data synchronization messages includes an identification of a synchronization scope of the repository. The identification additionally may identify a class of the data.

According to another embodiment of the method of the present invention, the local node receives a data synchronization message that includes an event instance notification of a remote repository. The local node includes a local repository, which is updated the event data of the event instance notification. When the local node obtains an event instance notification from a local client, it is packaged in a data synchronization message and communicated from the local node to the remote nodes via the multicast communication link.

According to another embodiment of the method of the present invention, a lost message of a sequence of received messages is detected and recovered. Each of the data synchronization messages includes an identification of sequence number and source of last update. The detecting step detects a missing sequence number corresponding to the lost message. The recovering step sends a data synchronization message via the multicast communication link requesting the lost message.

According to another embodiment of the method of the present invention, a duplicate message capability is provided. Each of the data synchronization messages includes an identification of sequence number and source of last update. The method detects that a received one of the data synchronization messages is a duplicate of a previously received data synchronization message, except for a different source of last update. A data synchronization message requesting a resend of the duplicate message from one of the different sources of last update is then sent via the multicast communication link.

According to another embodiment of the method of the present invention, a response storm capability is provided. When a received data synchronization message requires a response data synchronization message, the sending of the response data synchronization message is randomly delayed up to a predetermined amount of time to avoid a response storm. The predetermined amount of time is specified in the received data synchronization message. The response message is canceled if a valid response data synchronization message is first received from another remote node.

According to another embodiment of the method of the present invention, a local repository is initialized by communicating a copy of the data of another repository via a point-to-point communication link between the local node and a single one of the remote nodes.

The synchronized repository provider of the present invention comprises a data communication device that synchronizes data of a repository by communicating data synchronization messages concerning the data thereof in a multicast mode via a multicast communication link that interconnects all of the nodes. The communication device includes the capability to perform one or more of the aforementioned embodiments of the method of the present invention.

According to another embodiment of the synchronized provider of the present invention, the communication device includes a send thread that sends outgoing ones of the data synchronization messages and a receive thread that receives incoming ones of the data synchronization messages.

According to another embodiment of the synchronized provider of the present invention, the communication device further comprises a client process for processing (a) a client request to send one or more of the outgoing data synchronization messages and (b) one or more of the incoming messages.

According to another embodiment of the synchronized provider of the present invention, at least one of the data synchronization messages is a member of the group that consists of: event notification, lost message and duplicate message.

According to another embodiment of the synchronized provider of the present invention, the communication device further comprises a sent message map and a receive message map. The send thread saves sent messages to the sent message map. The receive thread accesses at least one of the sent message map and the received message map when processing a lost message.

According to another embodiment of the synchronized provider of the present invention, the receive thread accesses at least one of the sent message map and the received message map when processing a duplicate message.

Other and further objects, advantages and features of the present invention will be understood by reference to the following specification in conjunction with the annexed drawings, wherein like parts have been given like numbers.

### BRIEF DESCRIPTION OF THE DRAWINGS

Other and further objects, advantages and features of the present invention will be understood by reference to the following specification in conjunction with the accompanying drawings, in which like reference characters denote like elements of structure, and:

FIG. 1 is a block diagram of a system that includes the data synchronization device of the present invention;

FIG. 2 is a block diagram that shows the communication paths between various runtime system management components of a data synchronization device according to the present invention;

FIG. 3 is a block diagram that shows the communication links between different computing nodes used by the data synchronization devices of the present invention;

FIG. 4 is a block diagram showing a synchronization scope of the data synchronization devices of the present invention;

FIG. 5 is a block diagram that further shows the communication links between different computing nodes used by the data synchronization devices of the present invention; and

FIG. 6 is a block diagram of a data synchronizer of the present invention.

### DESCRIPTION OF THE PREFERRED EMBODIMENTS

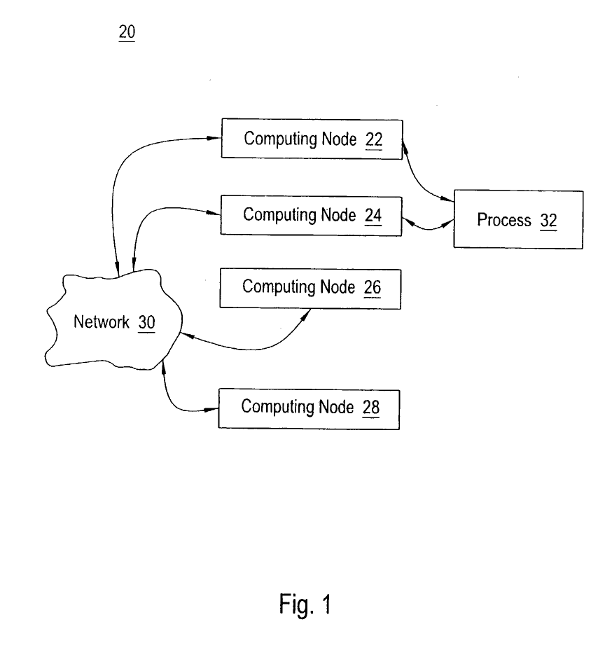

Referring to FIG. 1, a system 20 includes a plurality of computing nodes 22, 24, 26 and 28 that are interconnected via a network 30. Network 30 may be any suitable wired, wireless and/or optical network and may include the Internet, an Intranet, the public telephone network, a local and/or a wide area network and/or other communication networks. Although four computing nodes are shown, the dashed line between computing nodes 26 and 28 indicates that more or less computing nodes can be used.

System 20 may be configured for any application that keeps track of events that occur within computing nodes or are tracked by one or more of the computing nodes. By way of example and completeness of description, system 20 will be described herein for the control of a process 32. To this end, computing nodes 22 and 24 are disposed to control, monitor and/or manage process 32. Computing nodes 22 and 24 are shown with connections to process 32. These connections can be to a bus to which various sensors and/or control devices are connected. For example, the local bus for one or more of the computing nodes 22 and 24 could be a Fieldbus Foundation (FF) local area network. Computing nodes 26 and 28 have no direct connection to process 32 and may be used for management of the computing nodes, observation and other purposes.

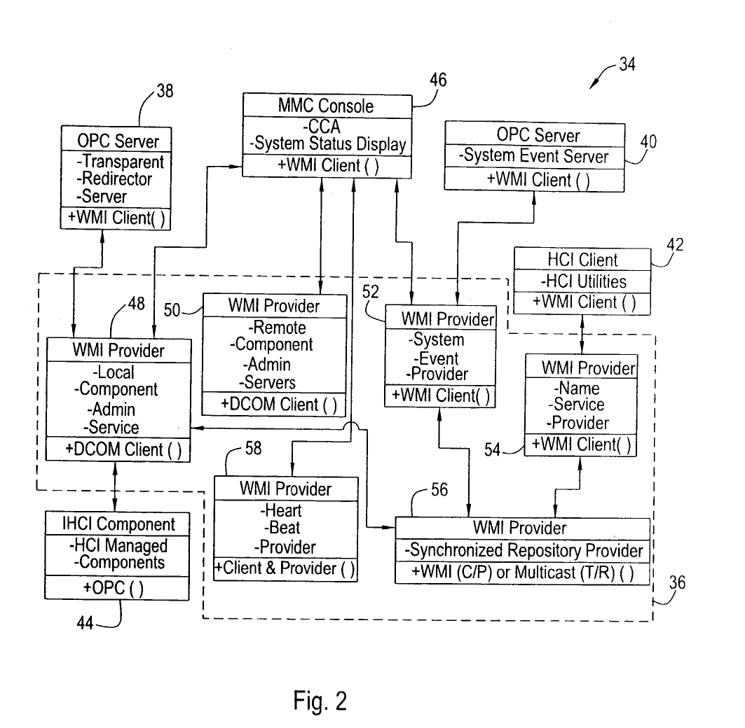

Referring to FIG. 2, computing nodes 22, 24, 26 and 28 each include a node computer 34 of the present invention. Node computer 34 includes a plurality of run time system components, namely, a WMI platform 36, a redirector server 38, a System Event Server (SES) 40, an HCl client utilities manger 42, a component manager 44 and a system display 46. WMI platform 36 includes a local component administrative service provider 48, a remote component administrative provider 50, a System Event Provider (SEP) 52, a Name Service Provider (NSP) 54, a Synchronized Repository Provider (SRP) 56 and a heart beat provider 58. The lines in FIG. 2 represent communication paths between the various runtime system management components.

According to the present invention, SRP 56 is operable to synchronize the data of repositories in its computing node with the data of repositories located in other computing nodes of system 20. For example, each of the synchronized providers of a computing node, such as SES 40, SEP 50, NSP 54 and heart beat provider 58 has an associated data repository and is a client of SRP 56.

System display 46 is a system status display and serves as a tool that allows users to configure and monitor computing nodes 22, 24, 26 or 28 and their managed components, such as sensors and/or transducers that monitor and control process 32. System display 46 provides the ability to perform remote TPS node and component configuration. System display 46 receives node and system status from its local heart beat provider 58 and SEP 52. System display 46 connects to local component administrative service provider 48 of each monitored node to receive managed component status.

NSP 54 provides an alias name and a subset of associated component information to WMI clients. The NSP 54 of a computing node initializes an associated database from that of another established NSP 54 (if one exists) of a different computing node, and then keeps its associated database synchronized using the SRP 56 of its computing node.

SEP 52 publishes local events as system events and maintains a synchronized local copy of system events within a predefined scope. SEP 52 exposes the system events to WMI clients. As shown in FIG. 2, both system display 46 and SES 40 are clients to SEP 52.

Component manager 44 monitors and manages local managed components. Component manager 44 implements WMI provider interfaces that expose managed component status to standard WMI clients.

Heart beat provider 58 provides connected WMI clients with a list of all the computing nodes currently reporting a heart beat and event notification of the addition or removal of a computing node within a multicast scope of heart beat provider 58.

SRP 56 performs the lower level inter node communications necessary to keep information synchronized. SEP 52 and NSP 54 are built based upon the capabilities of SRP 56. This allows SEP 52 and NSP 54 to maintain a synchronized database of system events and alias names, respectively.

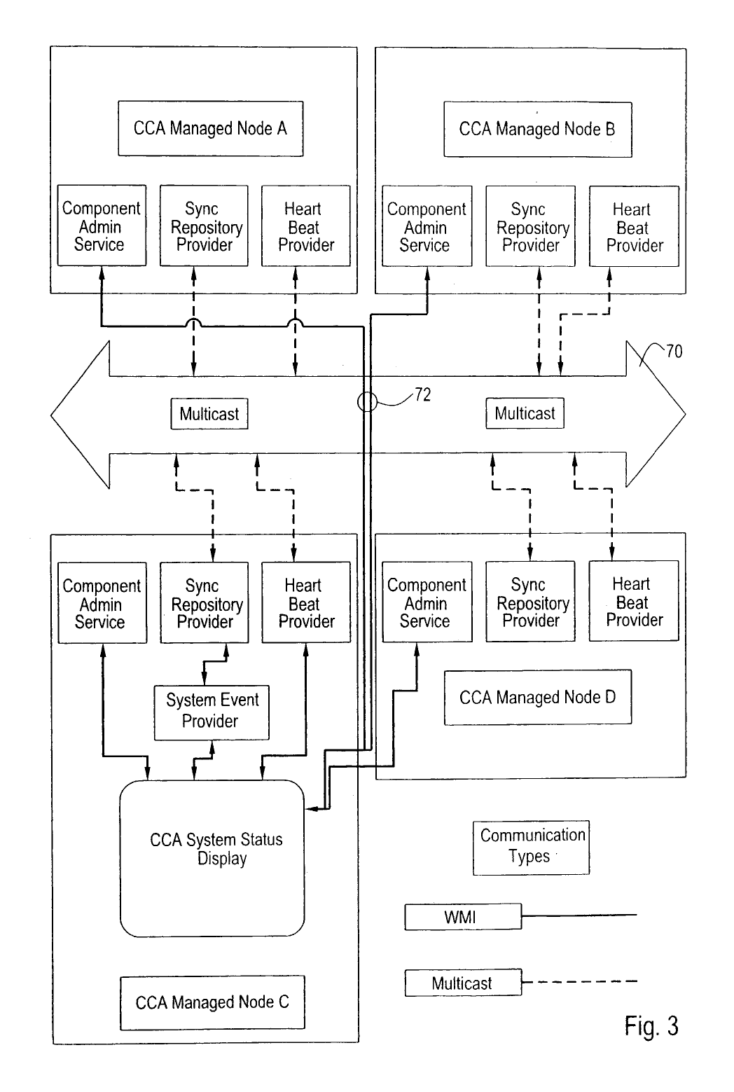

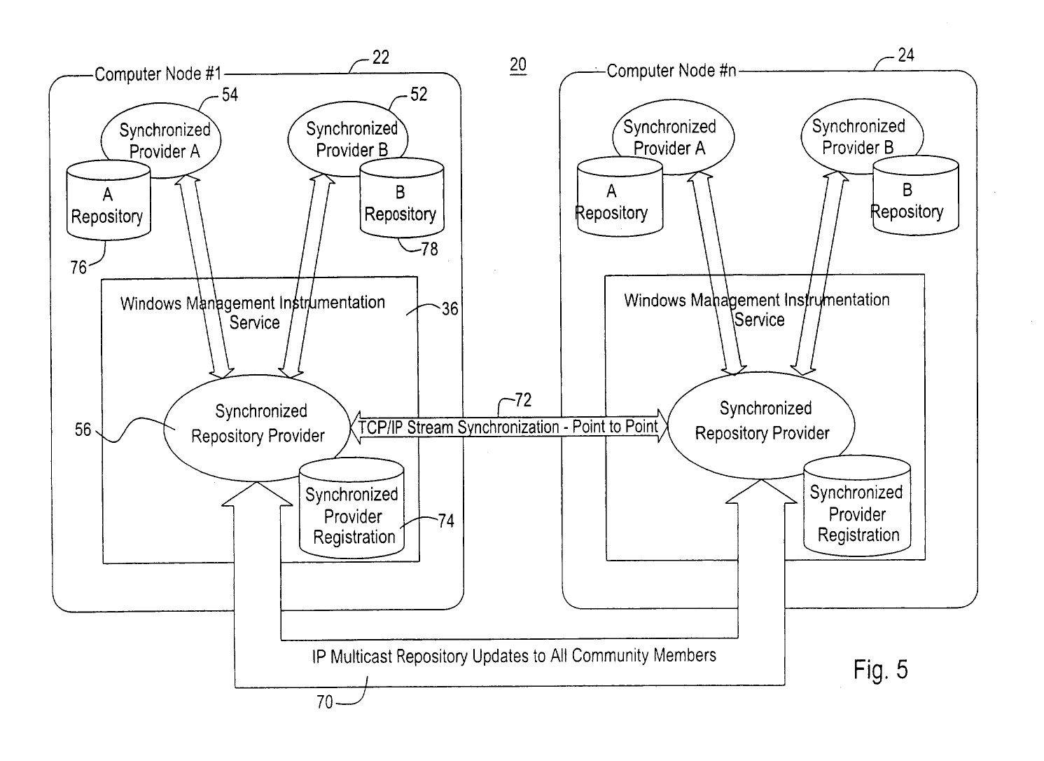

Referring to FIGS. 3 and 5, SRP 56 and heart beat provider 58 use multicast for inter node communication. System display 46, on the other hand, uses the WMI service to communicate with its local heart beat provider 58 and SEP 52. System display 46 also uses the WMI service to communicate with local component Administrative service provider 48 and remote component administrative service provider 50 on the local and remote managed nodes.

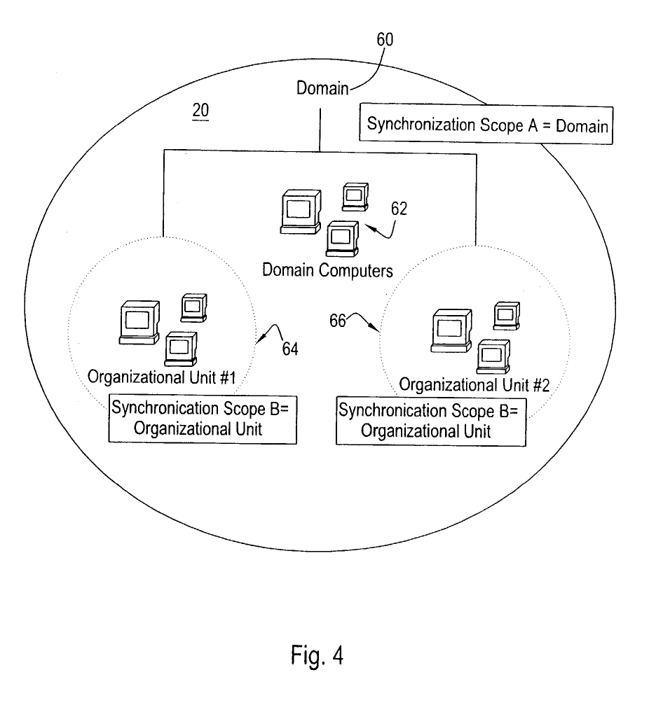

Referring to FIG. 4, system 20 includes a domain 60 of computing nodes that includes computing nodes 62, computing nodes 64 (organizational unit #1) and computing nodes 66 (organizational unit #2). A synchronized provider, such as NSP 54, can have a scope A of synchronization that includes all of domain 60 (i.e., computing nodes 62, 64 and 66) or a scope B that includes just the computing nodes 64 or 66.

Referring to FIGS. 3 and 5, communication links among the nodes are shown as a multicast link 70 and point-to-point link 72. Multicast link 70 and point-to-point link 72 are shown as interconnecting two or more of n nodes in system 20. For example, computing nodes 22 and 24 are shown as connected to one another for data synchronization. It will be appreciated that other active computing nodes in system 20 are interconnected with multicast link 70 and are capable of having a point-to-point link 72 established therewith. The SRP 56 of computing node 22 communicates with the SRP 56 of all computing nodes in the domain of system 20 (including computing node 24) via multicast link 70.

Each of the computing nodes in system 20 are substantially identical so that only computing node 22 will be described in detail. Computing node 22 includes SRP 56, a synchronized provider registration facility 74, and a plurality of synchronized providers, shown by way of example as NSP 54 and SEP 52. It will be appreciated that computing node 22 may also include the other synchronized providers shown in FIG. 2, as well as others.

NSP 54 has an associated NSP data repository 76 and SEP 52 has an associated SEP data repository 78. NSP 54 and NSP data repository 76 are each labeled as A, denoting a synchronization scope of A (FIG. 4). SEP 52 and SEP data repository 78 are each labeled as B, denoting a synchronization scope of B (FIG. 4). Upon start up or configuration, the synchronization scope A of NSP 54 and B of SEP 52 are registered with synchronization provider facility 74. In addition, a class of data within the synchronization scope is also registered for NSP 54 and SEP 52. That is, SEP 52, for example, may only need a limited class of the total event data available from a SEP data repository 78 in other nodes of system 20.

SRP 56 and synchronized providers NSP 54 and SEP 52 communicate with one another via the WMI facility 36 in computing node 22. For example, SEP 52 records new event instances of process 32 (FIG. 1) in SEP data repository 78 and notifies SRP 56 of such new event instances. SRP 56 packages the new event instances and multicasts the package via multicast link 70 to other computing nodes (including computing node 24) in system 20. The SRP 56 of each of the receiving nodes unwraps the package to determine if the packaged event instances match the scope and class of the associated SEP 52 and SEP data repository 78. If so, the event instances are provided to the associated SEP 52 via the local WMI facility.

In addition to event notifications, an SRP 56 also uses multicast link 70 in the exchange of control messages of various types with the SRP 56 of other computing nodes in system 20. For example, upon startup, SEP data repository 78 will need to be populated with event data of its registered scope and class. SRP 56 of computing node 22 sends a control message via multicast link 70 requesting a download of the needed data. A receiving node, for example computing node 24, inspects the control message and if it has the available data replies with a control message. SRP 56 of computing node 22 then causes WMI facility 36 to set up point-to-point link 72 with SRP 56 of computing node 24 and the requested data is downloaded as a TCP/IP stream and provided to SEP 52 of computing node 22.

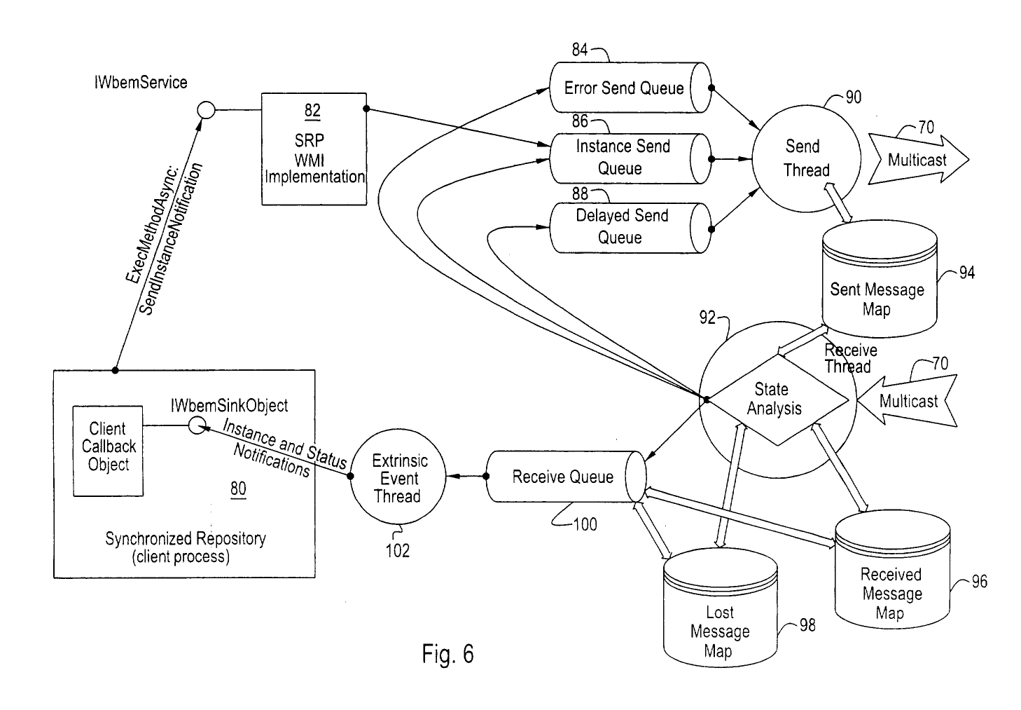

Referring to FIG. 6, SRP 56 includes a client process 80, an SRP WMI implementation 82, a send thread 90 and a receive thread 92. An error send queue 84, an instance sent queue 86 and a delayed send queue 88 are disposed as input queues to send thread 90. A sent message map 94 is commonly used by send thread 90 and receive thread 92. A received message map 96 and a lost message map 98 are associated with receive thread 92.

To send an event instance, client process 80 communicates with the client (e.g., SEP 52) via the WMI facility 36 to obtain the event instance and provide it to SRP WMI implementation 82. WMI implementation 82 packages the event instance as an instance notification and places it in instance send queue 86. Send thread 90 then sends the instance notification via multicast link 70 to other computing nodes in system 20. Send thread 90 also places the sent instance notification in sent message map 94.

Control messages from remote computing nodes are received by receive thread 92 via multicast link 70. Receive thread 92 includes a state analysis process that inspects incoming messages and determines their nature and places them in received message map 96. If an incoming message is an instance notification that matches the synchronization scope and class of a local synchronized provider (e.g., SEP 52), it is placed in receive queue 100. Extrinsic thread 102 provides the incoming instance notifications to client process 80, which in turn provides them to the appropriate synchronized provider (e.g., SEP 52).

Should the state analysis process of receive thread 92 detect that an incoming message is lost or missing, an error message is packaged for the sender, stored in lost message map 98 and placed in error send queue 84 for send thread 90 to multicast on multicast link 70. Upon receiving the error message, the receive thread 92 of the sender of the original message checks its sent message map to verify that is the sender. The original message is then resent. Upon receipt, receive thread 92 checks sent message map 94 to match this incoming message with a sent error message. If verified, receive thread 92 removes or otherwise inactivates the error message previously posted to lost message map 98.

The foregoing and other features of the SRP 56 of the present invention will be further described below.

### Synchronized Repository Provider

SRP 56 is the base component of SEP 52 and NSP 54. SEP 52 and NSP 54 provide a composite view of a registered instance class. SEP 52 and NSP 54 obtain their respective repository data through a connectionless, reliable protocol implemented by SRP 56.

SRP 56 is a WMI extrinsic event provider that implements a reliable Internet Protocol (IP) multicast based technique for maintaining synchronized WBEM repositories of distributed management data. SRP 56 eliminates the need for a dynamic instance provider or instance client to make multiple remote connections to gather a composite view of distributed data. SRP 56 maintains the state of the synchronized view to guarantee delivery of data change events. A connectionless protocol (UDP) is used which minimizes the effect of network/computer outages on the connected clients and servers. Use of IP multicast reduces the impact on network bandwidth and simplifies configuration.

SRP 56 implements standard WMI extrinsic event and method provider interfaces. All method calls are made to SRP 56 from the Synchronized Provider (e.g., SEP 52 or NSP 54) using the IWbemServices::ExecMethod[Async]() method. Registration for extrinsic event data from SRP 56 is through a call to the SRP implementation of IWbemServices::ExecNotificationQuery[Async](). SRP 56 provides extrinsic event notifications and connection status updates to SEP 52 and NSP 54 through callbacks to the client implementation of IWbemObjectSink::Indicate() and IWbemObjectSink::SetStatus(), respectively. Since only standard WMI interfaces are used, (installed on all Win2K computers) no custom libraries or proxy files are required to implement or install SRP 56.

To reduce configuration complexity and optimize versatility, a single IP multicast address is used for all registered clients (Synchronized Providers). Received multicasts are filtered by WBEM class and source computer Active Directory path and then delivered to the appropriate Synchronized Provider. Each client registers with SRP 56 by WBEM class. Each registered class has an Active Directory scope that is individually configurable.

SRP 56 uses IP Multicast to pass both synchronization control messages and repository updates reducing notification delivery overhead and preserving network bandwidth. Repository synchronization occurs across a Transmission Control Protocol/Internet Protocol (TCP/IP) stream connection between the synchronizing nodes. Use of TCP/IP streams for synchronization reduces the complexity multicast traffic interpretation and ensures reliable point-to-point delivery of repository data.

Synchronized Providers are WBEM instance providers that require synchronization across a logical grouping of computers. These providers implement the standard IWbemServices, IWbemProviderInit, and IWbemEventProvider, as well as IWbemObjectSink to receive extrinsic event notifications from SRP 56. Clients connect to the Synchronized Provider via the IWbemServices interface. The WMI service (winmgmt.exe) will initialize the Synchronized Provider via IWbemProviderInit and will register client interest in instance notification via the IWbemEventProvider interface.

Synchronized Providers differ from standard instance providers in the way that instance notifications are delivered to clients. Instead of delivering instance notifications directly to the IWbemObjectSink of the winmgmt service, Synchronized Providers make a connection to SRP 56 and deliver instance notifications using the SRP SendInstanceNotification() method. The SRP then sends the instance notification via multicast to all providers in the configured synchronization group. Instance notifications received by SRP 56 are forwarded to the Synchronized Provider via extrinsic event through the winmgmt service. The Synchronized Provider receives the SRP extrinsic event, extracts the instance event from the extrinsic event, applies it to internal databases as needed, and then forwards the event to connected clients through winmgmt.

Synchronized data is delivered to the Synchronized Provider through an extrinsic event object containing an array of instances. The array of objects is delivered to the synchronizing node through a TCP/IP stream from a remote synchronized provider that is currently in-sync. The Synchronized Provider SRP client must merge this received array with locally generated instances and notify remote Synchronized Providers of the difference by sending instance notifications via SRP 56. Each Synchronized Provider must determine how best to merge synchronization data with the local repository data.

Client applications access synchronized providers (providers which have registered as clients of the SRP) as they would for any other WBEM instance provider. The synchronized nature of the repository is transparent to clients of the synchronized provider.

SRP 56 will be configured with a Microsoft Management Console (MMC) property page that adjusts registry settings for a specified group of computers. SRP configuration requires configuration of both IP Multicast and Active Directory Scope strings.

By default, SRP 56 will utilize the configured IP Multicast (IPMC) address for heartbeat provider 58 found in the HKLM\Software\Honeywell\FTE registry key. This provides positive indications as to the health of the IP Multicast group through LAN diagnostic messages (heartbeats). The UDP receive port for an SRP message is unique (not shared with the heartbeat provider 58). Multicast communication is often restricted by routers. If a site requires synchronization of data across a router, network configuration steps may be necessary to allow multicast messages to pass through the router.

Active Directory Scope is configured per Synchronized Provider (e.g., SEP 52 or NSP 54). Each installed Client will add a key with the name of their supported WMI Class to the HKLM\Software\Honeywell\SysMgmt\SRP\Clients key. To this key, the client will add a Name and Scope value. The Name value will be a REG_SZ value containing a user-friendly name to display in the configuration interface. The Scope value will be a REG_MULTI_SZ value containing the Active Directory Scope string(s).

The SRP configuration page will present the user with a combo box allowing selection of an installed SRP client to configure. This combo box will be populated with the Name values for each client class listed under the SRP\Clients key. Once a client provider has been selected, an Active Directory Tree is displayed with checkbox items allowing the user to select the scope for updates. It will be initialized with check marks to match the current client Scope value.

To pass instance contents via IP Multicast, the IWbemClassObject properties must be read and marshaled via a UDP IP Multicast packet to the multicast group and reconstituted on the receiving end. Each notification object is examined and the contents written to a stream object in SRP memory. The number of instance properties are first written to the stream followed by all instance properties—written in name (BSTR), data (VARIANT) pairs. The stream is then packaged in an IP Multicast UDP data packet and transmitted. When received, the number of properties is extracted and the name/data pairs are read from the stream. A class instance is created and populated with the received values and then sent via extrinsic event to the winmgmt service for delivery to registered clients (Synchronized Providers). Variants cannot contain reference data. Variants containing safe arrays of values will be marshaled by first writing the variant type followed by the number of instances contained in the safe array and then the variant type and data for all contained elements.

To avoid response storms, multicast responses are delayed randomly up to a requestor specified maximum time, before being sent. If a valid response is received by a responding node from another node before the local response is sent, the send will be cancelled.

SRP 56 is an infrastructure component that is used by both SEP 52 and NSP 54. SRP 56 may be used to synchronize the data of any WMI repository via IP multicast. SRP 56 can be used wherever a WMI repository needs to be kept synchronized across multiple nodes. In order to perform WMI repository synchronization, IP multicast must be available such that each node participating in the synchronization can send and receive Multicast messages to all other participating nodes. To perform this operation using WMI interfaces requires connection by the provider to the provider on all other nodes. Using SRP 56, a provider needs only connect to the local SRP 56 to receive updates from all other nodes. This mechanism is connectionless, yet reliable.

Clients of SRP 56 are WMI providers. Each client provider registers with SRP 56 on startup by identifying its WBEM object class and the scope of repository synchronization.

Following are examples of synchronized providers implementing an SRP Client interface for maintaining synchronization of their repositories.

### System Event Provider

SEP 52 maintains a synchronized repository of managed component and other system related events. SRP 56 is utilized to keep the event view synchronized within a specified Active Directory scope. Events are posted, acknowledged and cleared across the multicast group.

The multicast group address and port as well as the Active Directory Scope are configured from a Synchronized Repository standard configuration page. Like all other standard configuration pages, this option will be displayed in a Computer Configuration context menu by system display 46.

A default SEP 52 client configuration will be written to an SRP client configuration registry key. The key will contain the name and scope values. The name is the user-friendly name for the SEP Service and Scope will default to “TPSDomain—indicating the containing active directory object (TPS Domain Organizational Unit).

### Name Service Provider

The Name Service provider (NSP 54) is responsible for resolving HCl/OPC alias names. Each node containing HCl clients or servers must have a local NSP 54 in order to achieve fault tolerance. NSP 54 will create and maintain a repository of alias names found on the local machine and within the scope of a defined multicast group.

NSP 54 is implemented as a WMI provider providing WMI clients access to the repository of alias names. NSP 54 is also implemented as a WMI client to SRP 56, which provides event notification of alias name modifications, creations, and deletions within the scope of the multicast group. HCl-NSP utilizes a worker thread to monitor changes to local alias names. Local alias names are found in the registry and in a HCl Component Alias file.

The multicast group address and port as well as Active Directory Scope will be configured from a Synchronized Repository standard configuration page. Like all other standard configuration pages, this option will be displayed in the Computer Configuration . . . context menu. The default NSP 54 SRP client configuration will be written to the key. The key will contain the Name and Scope values. Name is the user-friendly name for the Name Service and Scope will default to “*”—indicating that no filtering will be performed.

### Name Service Provider—SRP Client Object

The SRP client object implements the code that processes the InstanceCreation, InstanceModification, InstanceDeletion and extrinsic events from SRP 56. This object gets the SyncSourceResponse message with the enumerated alias name array from a remote node and then keeps it synchronized with reported changes from SRP 56.

### SRP Logical Design Scenarios

When a provider (e.g., SEP 52 or NSP 54) utilizing SRP 56 starts, it registers its class and synchronization scope with the SRP 56. SRP 56 then finds an existing synchronized repository source and returns this source name to the client provider. The client provider then makes a one-time WMI connection to the specified source and enumerates all existing instances—populating its local repository. The node is started and the client provider service is auto-started. Table 1 describes this process.

TABLE 1

| Event | Description of Event |
|---|---|
| 1 | The Client provider starts and during initialization invokes the |
| | RegisterClient() method on the SRP. |
| 2 | The SRP creates a class object to manage synchronization |
| | messages for the specified class and scope. |
| 3 | The SRP issues a SequenceMessage message specifying an initial |
| | state of 0 - requesting from other nodes the current repository state. |
| 4 | Listening SRPs receive the SequenceMessage and compare the |
| | incoming sequence number to their locally maintained sequence |
| | number for the given class and scope. |
| 5 | Since the local sequence number exceeds the incoming sequence |
| | number, the receiving nodes queue a SequenceMessage msg for |
| | transmittal. |
| 6 | One of the nodes transmits its SequenceMessage message. All |
| | other nodes receive the message, compare it to their local seq and |
| | if the same - remove their response message (SequenceMessage) |
| | from their message queue - avoiding a response storm. |
| 7 | The SRP on the node starting up receives the SequenceMessage |
| | message, evaluates the message and determines that |
| | synchronization is required. |
| 8 | A delayed delivery SyncRequestTimeout message is queued on the |
| | client receive queue, blocking receipt of instances until |
| | synchronization is complete. If this message notification delay |
| | times-out, an event will be logged and the client will receive the |
| | SyncSourceTimeout message. |
| 9 | A RequestSyncSourceMessage message is queued to the error |
| | message send queue and the sequence number is set to the |
| | sequence number specified in the evaluated SequenceMessage |
| | message. |
| 10 | Nodes receiving the RequestSyncSourceMessage evaluate the |
| | message sequence number and if they qualify post a |
| | SyncSourceResponseMessage to the DelayedMsgQueue. If a |
| | response from another node is received while waiting to send the |
| | local response, the local response will be cancelled. If no responses |
| | are heard, the SyncSourceResponseMessage will be transmitted. |
| 11 | The requesting node (the node starting up) receives the |
| | SyncSourceResponseMessage and establishes a TCP/IP stream |
| | connection to the responding node and downloads a current |
| | enumeration of class instances. Also downloaded is a list of re- |
| | ceived message signatures that contributed to the current repository |
| | state. |
| 12 | The SyncSourceResponseMessage complete with instance |
| | enumeration is queued and delivered to the registered client |
| | provider. |

As a provider (e.g., NSP 54) that utilizes SRP 56 starts up, it registers its class and synchronization scope with SRP 56. SRP 56 attempts to find an existing synchronized repository source; failing to do this it will assume that it is the first node up and initialize NSP data repository 76. The node is started and the client provider service is auto-started. Table 2 describes this process.

TABLE 2

| Event | Description of Event |
|---|---|
| 1 | The Client provider starts and during initialization invokes the |
| | RegisterClient() method on the SRP. |
| 2 | The SRP creates a class object to manage synchronization |
| | messages for the specified class and scope. |
| 3 | The SRP issues a SequenceMessage message specifying an initial |
| | state of 0 - requesting from other nodes the current repository state. |
| 4 | A RequetSyncSourceMessage is sent and a SyncSourceTimeout |
| | message is queued. |
| 5 | No response is heard and the SyncSourceTimeout delay period |
| | expires causing an event to be logged and the SyncSourceTimeout |
| | to be delivered to the registered client provider. |

WMI providers generate WMI instance events to notify connected clients of instance creation, deletion or modification. These events are sent to SRP 56 by its client providers for multicast to the SRP 56 of other computing nodes connected in system 20. A condition has changed forcing the client provider (e.g., SEP 52) to generate an instance event. All SRPs for the registered client provider are in sync. Table 3 describes this process.

TABLE 3

| Event | Description of Event |
|---|---|
| 1 | The Client provider invokes the SRP SendInstanceNotification() |
| | method passing a WBEMClassObject containing the object |
| | instance. |
| 2 | The SRP packages the object instance in a multicast message and |
| | queues the message for delivery to the SRP multicast group. |
| 3 | The SRP completes and pending receive operations ensuring |
| | current sequence number synchronization and then updates the |
| | queued message sequence number and multicasts the message. |
| 4 | Listening SRPs receive the instance message and verify against |
| | their local sequence number for the specified class and scope. |
| 5 | The listening SRP sequence number is updated and the incoming |
| | message is forwarded as a WMI event to the registered client. |

SRP 56 maintains the current state of a synchronized repository using object class, synchronization scope, sequence number, source of last update and a received message list. If a message is received out of order (not late) a “Lost” message(s) is queued to the client and then the received message is queued. This “Lost” message will not be processed until a timeout period for receiving the lost message has expired. SRP 56 queues a LostMessage message for multicast to the SRP multicast group—requesting retransmittal of the missing message. If the missing message is received it will replace the “Lost” message in the client receive queue and the queue will continue to be processed. If the LostMessage placeholder times out, the SRP will initiate a resync.

A condition has changed forcing the client provider to generate an instance event. For some reason a node fails to receive the message (possibly dropped during transport due to buffering limitations etc . . . (IP Multicast delivery is not guaranteed)). Table 4 describes this process.

TABLE 4

| Event | Description of Event |
|---|---|
| 1 | The Client provider invokes the SRP SendInstanceNotification() |
| | method passing a IWbemClassObject containing the object |
| | instance. |
| 2 | The SRP packages the object instance in a multicast message and |
| | queues the message for delivery to the SRP multicast group. |
| 3 | The SRP completes pending receive operations ensuring current |
| | sequence number synchronization and then updates the queued |
| | message sequence number and multicasts the message. |
| 4 | Listening SRPs receive the instance message and verify against |
| | their local sequence number for the specified class and scope - the |
| | message is found to have skipped a sequence number. Multiple |
| | messages may have been lost as long as a maximum number of lost |
| | messages (default of 5) have not been lost. If the maximum have |
| | been lost - a repository resynchronization will be triggered. Queued |
| | transmit messages will be applied to the resynced repository. |
| 5 | The SRP queues a LostMessage placeholder message in the receive |
| | message queue and follows it with the received message. |
| 6 | The SRP multicasts a LostMessage message to the SRP multicast |
| | group. |
| 7 | Listening SRPs receive the LostMessage message and if the |
| | LostMessage was sourced from their node (and has not reached its |
| | lifetime), place the message on the head of the instance send queue |
| 8 | The Lost message is retransmitted (with original sequence number |
| | and retransmittal flag set). |
| 9 | The node waiting for the lost message receives the message, inserts |
| | it into the LostMessage message placeholder and forwards it to the |
| | registered client. |
| 10 | If the LostMessage message in the receive queue times-out before |
| | the lost message is retransmitted it can be assumed that the |
| | message no longer exists and will not be retransmitted. The |
| | LostMessage event will be sent to the registered client provider and |
| | a repository resynchronization will be requested. |
| 11 | The signature for the LostMessage (if known through rcvd message |
| | list evaluation) is appended to the RequestSyncSourceMessage to |
| | ensure that responding synchronized sources can satisfy the |
| | requirement for the specified message. |

SRP 56 maintains the current state of a synchronized repository using class, synchronization scope, sequence number, and source of last update. If a message is received with the same sequence number but different source as a message previously processed, it is considered a duplicate and must be retransmitted by the sender with a valid sequence number. A condition has changed forcing the client provider to generate an instance event on 2 or more nodes simultaneously. Two nodes transmit with a current sequence number nearly simultaneously resulting in two message with the same sequence number, but different sources to be received.

TABLE 5

| Event | Description of Event |
|---|---|
| 1 | SRP receives a message with a sequence number that is less than |
| | the current sequence number. |
| 2 | The message is looked up in the recently received messages map |
| | and it is found that the message signature is different. |
| 3 | A duplicate error message is queued to the delayed message queue |
| | to indicate to the sending node that the message must be |
| | retransmitted. |
| 4 | The received message is processed. |
| 5 | If a duplicate message error is received from another node before |
| | the delayed send of the duplicate message occurs, the duplicate |
| | message error will be cancelled. |
| 6 | If the delayed event time expires, the duplicate message error is |
| | sent. |
| 7 | The original sending node receives the duplicate message error, |
| | sets the retransmittal flag on the sent message and reposts the |
| | message for transmission. |

SRP 56 maintains the current state of a synchronized repository using object class, synchronization scope, sequence number, source and timestamp of last update. If for some reason the multicast group is broken (i.e., a router in the middle of a network forwarding the multicasts has failed), two separately synchronized repository images will exist. When the network problem has been corrected, SRP 56 must merge the two views of the synchronized repository. It does not matter which side is selected as a master since the repository will merge to a single composite image.

A network anomaly has caused two valid SRP images to exist. The network is restored and SRP 56 must now merge the two valid repository images. A received message sequence number is less than the current sequence number and it does not have the retransmittal flag set. It is not a lost message. The timestamp is older than the last received message timestamp. Table 6 describes this process.

TABLE 6

| Event | Description of Event |
|---|---|
| 1 | SRP receives a message with the received message sequence |
| | number less than the current sequence number and it does not have |
| | the retransmittal flag set. |
| 2 | SRP examines the list of received messages that is concatenated on |
| | the sequence message. A list of lost messages is created by |
| | comparing the received list to the local Received Message List. |
| 3 | If lost messages are identified, a lost message placeholder for the |
| | first message identified is posted to the receive queue and a lost |
| | message error is posted to the delayed send queue. |
| 4 | If another lost message request for the same requested lost message |
| | is received before the request is transmitted, the request will be |
| | cancelled. |
| 5 | If the lost message is received, the next message in the lost list will |
| | be requested. |
| 6 | lf the lost message placeholder times out, a synchronization request |
| | will be posted, identifying the list of lost messages that are required |

for synchronization.

If in Step #3 no lost messages are identified, then the following alternative pathway of Table 7 should be followed:

TABLE 7

| Event | Description of Event |
|---|---|
| 3 | The received list of messages is checked against the local received |
| | message list to determine if the remote node is missing messages. |
| 4 | If additional messages are identified on the local node which have |
| | not been received by the remote node, a sequence message will be |
| | queued to the delayed send queue to ensure that the remote node |
| | will synchronize. |
| 5 | If no additional messages were found, the sequence number is |
| | examined. If the received sequence number is greater than the local |
| | number a resynchronization will be requested identifying the |
| | required sequence number. |
| 6 | If the received sequence number is less than the local number, a |
| | sequence message will be sent to ensure that the remote node |
| | evaluates synchronization requirements. |

While we have shown and described several embodiments in accordance with our invention, it is to be clearly understood that the same are susceptible to numerous changes apparent to one skilled in the art. Therefore, we do not wish to be limited to the details shown and described but intend to show all changes and modifications that come within the scope of the appended claims.

What is claimed is:

1. A method of communication between a local node and a plurality of remote nodes in a computing system for the synchronization of data, said method comprising communicating data synchronization messages concerning the data of a repository in a multicast mode via a multicast communication link that interconnects all of said nodes.

2. The method of claim 1, wherein at least one of said data synchronization messages includes an identification of synchronization scope of said repository.

3. The method of claim 2, wherein said identification additionally identifies a class of said data.

4. The method of claim 1, wherein at least one of said data synchronization messages is an event instance notification.

5. The method of claim 4, wherein said local node receives said at least one data synchronization message, wherein said repository is a remote repository, wherein said local node includes a local repository, and further comprising updating the data of said local repository with event data of said event instance notification.

6. The method claim of 4, wherein said local node obtains said event instance notification from a local client, and said communicating step sends said at least one data synchronization message from said local node to said remote nodes via said multicast communication link.

7. The method of claim 1, wherein a sequence of said data synchronization messages is received by said local node, and further comprising detecting that at least one message of said sequence of data synchronization messages is lost and recovering said lost message.

8. The method claim 7, wherein each of said data synchronization messages includes an identification of sequence number and source of last update, wherein said detecting step detects a missing sequence number corresponding to said lost message, and wherein said recovering step sends a data synchronization message via said multicast communication link requesting said lost message.

9. The method of claim 1, wherein each of said data synchronization messages includes an identification of sequence number and source of last update, and further comprising detecting that a received one of said data synchronization messages is a duplicate of a previously received data synchronization message, except for a different source of last update; and sending a data synchronization message requesting a resend of the duplicate message from one of said different sources of last update via said multicast communication link.

10. The method of claim 1, wherein a received data synchronization message requires a response data synchronization message, and wherein said communicating step randomly delays sending said response data synchronization message up to a predetermined amount of time to avoid a response storm.

11. The method of claim 10, wherein said predetermined amount of time is specified in said received data synchronization message.

12. The method of claim 11, wherein said communicating step cancels sending said response message if a valid response data synchronization message is first received from another remote node.

13. The method of claim 1, wherein said local node sends one of said data synchronization messages that requires a response, and wherein said one data synchronization message specifies a predetermined amount of time within which said response can be transmitted.

14. The method of claim 1, further comprising communicating a copy of the data of a repository via a point-to-point communication link between said local node and a single one of said remote nodes.

15. A synchronized repository provider for communication between a local node and a plurality of remote nodes in a computing system comprising a data communication device that synchronizes data of a repository by communicating data synchronization messages concerning the data of said repository in a multicast mode via a multicast communication link that interconnects all of said nodes.

16. The synchronized repository provider of claim 15, wherein at least one of said data synchronization messages includes an identification of synchronization scope of said repository.

17. The synchronized repository provider of claim 16, wherein said identification additionally identifies a class of said data.

18. The synchronized repository provider of claim 15, wherein at least one of said data synchronization messages is an event instance notification.

19. The synchronized repository provider of claim 18, wherein said local node receives said at least one data synchronization message, wherein said repository is a remote repository, wherein said local node includes a local repository, and wherein the data of said local repository is updated with event data of said event instance notification.

20. The synchronized repository provider claim of 18, wherein said communication device obtains said event instance notification from a local client, and wherein said communication device sends said at least one data synchronization message from said local node to said remote nodes via said multicast communication link.

21. The synchronized repository provider of claim 15, wherein a sequence of said data synchronization messages is received by said local node, and said communication device detects that at least one message of said sequence of data synchronization messages is lost and performs a process to recover said lost message.

22. The synchronized repository provider claim 21, wherein each of said data synchronization messages includes an identification of sequence number and source of last update, wherein said communication device detects a missing sequence number corresponding to said lost message, and wherein said process sends a data synchronization message via said multicast communication link requesting said lost message.

23. The synchronized repository provider of claim 15, wherein each of said data synchronization messages includes an identification of sequence number and source of last update, and wherein said communication device detects that a received one of said data synchronization messages is a duplicate of a previously received data synchronization message, except for a different source of last update; and wherein said communication device sends a data synchronization message requesting a resend of the duplicate message from one of said different sources of last update via said multicast communication link.

24. The synchronized repository provider of claim 15, wherein a received data synchronization message requires a response data synchronization message, and wherein said communication device randomly delays sending said response data synchronization message up to a predetermined amount of time to avoid a response storm.

25. The synchronized repository provider of claim 24, wherein said predetermined amount of time is specified in said received data synchronization message.

26. The synchronized repository provider of claim 25, wherein said communicating step cancels sending said response message if a valid response data synchronization message is first received from another remote node.

27. The synchronized provider of claim 15, wherein said communication device sends one of said data synchronization messages that requires a response, and wherein said one data synchronization message specifies a predetermined amount of time within which said response can be transmitted.

28. The synchronized repository provider of claim 15, wherein said communication device also sends or receives a copy of the data of said repository via a point-to-point communication link between said local node and a single one of said remote nodes.

29. The synchronized provider of claim 15, wherein said communication device comprises a send thread for sending outgoing ones of said data synchronization messages and a receive thread for receiving incoming ones of said data synchronization messages.

30. The synchronized provider of claim 29, wherein said communication device further comprises a client process for processing (a) a client request to send one or more of said outgoing data synchronization messages and (b) one or more of said incoming messages.

31. The synchronized provider of claim 30, wherein at least one of said data synchronization messages is a member of the group which consists of: event notification, lost message and duplicate message.

32. The synchronized provider of claim 31, wherein said communication device further comprises a sent message map and a receive message map, wherein said send thread saves sent messages to said sent message map and wherein said receive thread accesses at least one of said sent message map and said received message map when processing a lost message.

33. The synchronized provider of claim 31, wherein said communication device further comprises a sent message map and a receive message map, wherein said send thread saves sent messages to said sent message map and wherein said receive thread accesses at least one of said sent message map and said received message map when processing a duplicate message.
